(19) United States
(12) Patent Application Publication
(10) Pub. No.: US 2006/0118237 A1
(43) Pub. Date: Jun. 8, 2006

(54) Polymer films having good print and heat seal properties and laminates prepared therewith

(75) Inventors: Mark Miller, Houston, TX (US); Scott D. Cooper, Humble, TX (US); Mark Leland, Houston, TX (US); Aiko Hanyu, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/003,269

(22) Filed: Dec. 3, 2004

(51) Int. Cl. B32B 27/08; B32B 27/32; B32B 15/08; B32B 27/10

(52) U.S. Cl. 156/308.2; 428/523; 428/461; 428/513; 428/35.7

(57) ABSTRACT

Disclosed is a laminate of a polymer film and substrate wherein the polymer film has good heat seal and printing properties. The polymer film is prepared from an isotactic polypropylene or propylene-ethylene copolymer prepared using a metallocene copolymer.

### BACKGROUND OF THE INVENTION

1. Field of the Invention

The present invention relates to polymer films. The present invention particularly relates to metallocene catalyzed polypropylene and ethylene-propylene copolymer films.

2. Background of the Art

Preparing films that can be used in printing and heat seal applications can be problematic. It is conventionally believed that polymer films that can be metalized or printed, can often be unsuitable for use as in heat seal applications. Solutions to this problem have included using very complex combination of resins and/or use with additional treatments such as surface degradation using peroxides.

The use of such complex materials and especially additional surface treatments can be both expensive and time consuming, making such applications inconvenient and capital intensive. In some applications these solutions are even impractical in industrial applications. It would be desirable in the art to produce polymers films and laminates having good heat seal properties that could also be used in printing applications.

### SUMMARY OF THE INVENTION

In one aspect, the invention is a multiple-layer polymer film having a first layer including at least one metallocene catalyzed isotactic polypropylene or polypropylene copolymer film having novel surface attributes. Attached to the first layer is a second layer including a polymer film.

In another aspect, the invention is a polymer laminate including a substrate and a layer of polymer film. The polymer film is a metallocene catalyzed isotactic polypropylene or polypropylene copolymer film having novel surface attributes.

In still another aspect, the invention is a process for preparing a multiple-layer polymer film or a polymer film laminate. The process includes applying a layer of polymer film to a substrate wherein the polymer is a metallocene catalyzed isotactic polypropylene or polypropylene copolymer having novel surface attributes

### BRIEF DESCRIPTION OF THE DRAWINGS

For a detailed understanding of the present invention, reference should be made to the following detailed description of the preferred embodiments, taken in conjunction with the accompanying drawings, in which like elements have been given like numerals, wherein:

FIG. 1 is graph showing the change in heat seal maximum force with temperature of an isotactic polypropylene copolymer film in Example 1;

FIG. 2 is graph showing the change in hot tack seal strength with temperature of an isotactic polypropylene copolymer film in Example 1;

FIG. 3 is graph showing the change in heat seal maximum force with temperature of a conventional polypropylene copolymer film in Comparative Example A;

FIG. 4 is graph showing the change in hot tack seal strength with temperature of a conventional polypropylene copolymer film in Comparative Example A; and

FIG. 5 is graph showing the retained surface treatment properties of a metallocene copolymer surface following corona discharge treatment from Example 2 and Comparative Example B.

### DETAILED DESCRIPTION OF INVENTION

In one embodiment, the invention is a polymer laminate including at least one substrate, and attached thereto, a layer of polymer film. The polymer used to prepare the polymer film may be a metallocene catalyzed isotactic polypropylene or polypropylene copolymer. The metallocene catalysts that may be useful for preparing the polymers include those having a metal complex of a compound containing a cyclopentadienyl ring. These catalysts are generally known in the art of preparing polymers as metallocene catalysts. Exemplary of such catalysts are those disclosed in: U.S. Pat. No. 5,324,800 to Welborn, et al.; U.S. Pat. Nos. 4,701,432 and 4,808,561, both to Welborn; U.S. Pat. No. 5,026,798 to Canich; U.S. Pat. No. 5,308,811 to Suga, et al.; U.S. Pat. No. 4,892,851 to Ewen, et al.; U.S. Pat. No. 5,444,134 to Matsumoto; U.S. Pat. No. 5,719,241 to Razavi; and U.S. Pat. No. 5,807,800 to Shamshoum, et al, all incorporated herein by reference.

The characteristics of polymers prepared using these catalysts may include an extremely narrow molecular weight distribution as compared with similar Ziegler-Natta polymerized polymers. These polymers may also have a very low volatile content, often referred to in the art as hexane extractable or xylene soluble content. Metallocene catalysts may be used to prepare homopolymers and copolymers of propylene that are isotactic.

The isotactic polypropylene copolymers may be prepared by polymerizing a mixed feed of ethylene and propylene in the presence of a metallocene catalyst. The copolymers may have a total ethylene content of from about 0 percent to about 9.5 percent. When the ethylene content is 0, the polymer is a polypropylene and not a copolymer of ethylene and propylene. In one embodiment, the total ethylene content of the isotactic polypropylene copolymers is from about 1 percent to about 7 percent. In still another embodiment, the total ethylene content of the isotactic polypropylene copolymers is from about 2 percent to about 6 percent. In another embodiment, the total ethylene content of the isotactic polypropylene copolymers is from about 3 percent to about 5 percent.

In another embodiment, the invention is a multiple-layer polymer film including at least one substrate polymer and attached thereto a layer of metallocene catalyzed isotactic polypropylene or polypropylene copolymer film. The multiple-layer films are capable of being printed. The good print qualities of the multiple-layer films of the present invention result from the fact that metallocene catalyzed isotactic polypropylene or polypropylene copolymer film has novel surface properties. Included in these properties may be the property of retaining good heat seal properties after being subjected to a corona discharge treatment. In a corona discharge treatment, one or both primary surfaces of a thermoplastic film are subjected to the ionization product of a gas, such as air, in close proximity with the film surface(s) so as to cause oxidation and/or other changes to the film surface(s). One of these changes is to modify the surface of the film to allow it more readily accept printing ink, pigment or metallic element than the surface of an otherwise similar film that has not been treated.

In one embodiment, an isotactic polypropylene or polypropylene copolymer film is passed between two conductors serving as electrodes, where the potential, usually an alternating potential of from about 5 to 20 kV and from 5 to 30 kHz, is applied between the electrodes to produce corona discharges. The corona discharge ionizes the air above the film surface, and there is a reaction with the molecules of the film surface. In another embodiment, an isotactic polypropylene or polypropylene copolymer film is treated with a polarized flame using a procedure such as that of U.S. Pat. No. 4,622,237, which is incorporated herein by reference, wherein a direct voltage is applied between a burner, a negative pole and a chill roll. The voltage applied is generally from 500 to 3000 volts “V.” In another embodiment, the range is from 1500 to 2000V. This process increases the acceleration of the ionized atoms, which impact the polymer surface with greater kinetic energy. Thermal stress on the polymer here is much lower than for standard flame-treatment, and the sealing properties of the treated side in the films obtained may be even better than those of the non-treated side. Any such method, or any other method of corona treatment known to be useful to those of ordinary skill in the art of preparing films for printing may be used with the present invention.

The multiple-layer polymer films may also be metallized, following corona discharge treatment. In a vacuum metallization process, one side of a polymer film is exposed to a vaporous metal, usually aluminum vapor, while being cryogenically chilled on the other side. The resultant film will typically have a layer of metal having a thickness of from about 3 nm to about 30 nm. The films may also range in thickness from about 12 microns to about 50 microns. In addition to aluminum, other metals that may be used with the process of the present invention include gold, copper, silver, chromium, and mixtures thereof. Metal deposition processes useful with the present invention include the vacuum deposition described above, but also include sputtering, and electroplating. Any method of depositing a layer of metal on the surface of a polymer known to be useful to those of ordinary skill in the art of performing such processes may be used.

The films used to prepare the multiple-layer polymer films may be both corona treated and printed and still retain their good heat seal properties. A film having good heat seal properties has a comparatively low sealing temperature. During sealing, printing or metallization, the surface of the polymer film may be exposed to heat. The more low molecular weight components present in a film, the more likely that those components will volatilize and escape from the polymer film and cause surface defects in the seal, printing or metal layer. In severe cases, the volatilization of the low molecular weight components may, for example, cause visible bubbles or pits in the surface of a metal layer, disrupting its integrity as a vapor or gas barrier. In very severe cases, this may cause the pigments or metal to lose adhesion and flake off of the polymer film or a seal to fail. The multiple layer films and laminates prepared with metallocene catalyzed isotactic polypropylene or polypropylene copolymer may have minimal or low frequency of such surface defects or even be surface defect free.

The metallocene catalyzed isotactic polypropylene or polypropylene copolymers used to prepare the multiple-layer polymer films may be used to produce films that have novel surface properties including good heat seal strength, relatively low melting points, and good tack seal strength. The isotactic polypropylene or polypropylene copolymers used to prepare the multiple-layer polymer films have a melting point of from about 95° C. to about 150° C. In one embodiment, the metallocene catalyzed isotactic polypropylene or polypropylene copolymer films used to prepare the laminates of the present invention have a melting point of from about 105° C. to about 140° C. Polymers useful for preparing the laminates of the present invention have a melt flow index of from about 1 to about 50 grams “g” per 10 minutes as determined using ASTM-D1238. In another embodiment, the polymers useful for preparing the laminates have a melt flow index of from about 5 to about 20 g per 10 minutes.

The laminates of the present invention include a substrate. Suitable substrates useful with the present invention include metal foil, paper, and films of other polymers. The present invention is particularly useful with laminates wherein the laminate is a package requiring labeling, such as, for example, a food container such as a potato chip bag. The multiple-layer film having an isotactic polypropylene copolymer surface of the present invention may be subjected to corona treatment, printed and then applied to the substrate. In anther embodiment, the multiple-layer film having an isotactic polypropylene copolymer surface of the present invention may be applied to the substrate and then printed.

An embodiment of the invention is a process for preparing a multiple-layer polymer film or a polymer film laminate. Included in the process is applying a layer of polymer film to a substrate wherein the polymer is a metallocene catalyzed isotactic polypropylene or polypropylene copolymer having novel surface attributes. The substrate is either a polymer film in the case of a multiple-layer film, or a different substrate in the case of a laminate. If the substrate is a polymer film, the polymer may be either the same as or different from the metallocene catalyzed isotactic polypropylene or polypropylene copolymer film. In either process, any method for applying polymer films to a substrate known to those of ordinary skill in the art preparing such multiple-layer films or laminates to be useful may be used with the present invention. Such methods include but are not limited to the use of heat sealing, adhesives, welding, and the like.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

A random copolymer of propylene and ethylene prepared using a metallocene catalyst and having an ethylene content of 4.7% is used to prepare a film. This polymer is commercially available as TOTAL PETROCHEMICALS EOD01-05. The film is subjected to a corona treatment using an ENERCON CORNONAT treater using a ceramic electrode. The instrument applies 4 kilowatts of power to 2 mil films at a line speed of 200 feet per minute.

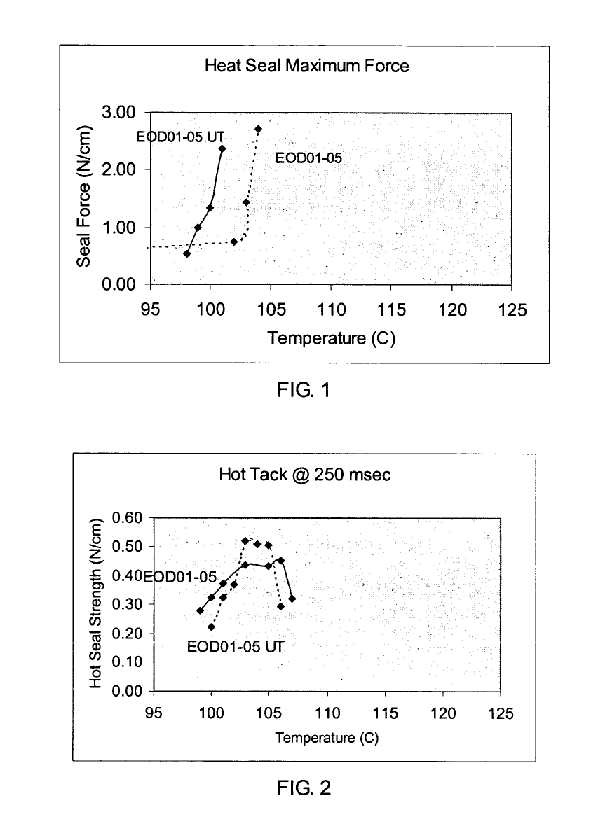

The copolymer has a melting point of about 119° C. and a nominal melt index of 9 g/10 minutes. The film, both treated and untreated is tested for heat seal properties. A graph showing the test results for Heat Seal maximum force is displayed as FIG. 1. A graph showing the test results for Hot Tack Seal Strength is displayed as FIG. 2.

### Comparative Example A

A conventional copolymer of propylene and ethylene prepared using a Ziegler Natta catalyst and having an ethylene content of 7% is used to prepare a film. This polymer is commercially available as TOTAL PETROCHEMICALS EOD94-21. The film is subjected to a corona treatment identical to that of Example 1.

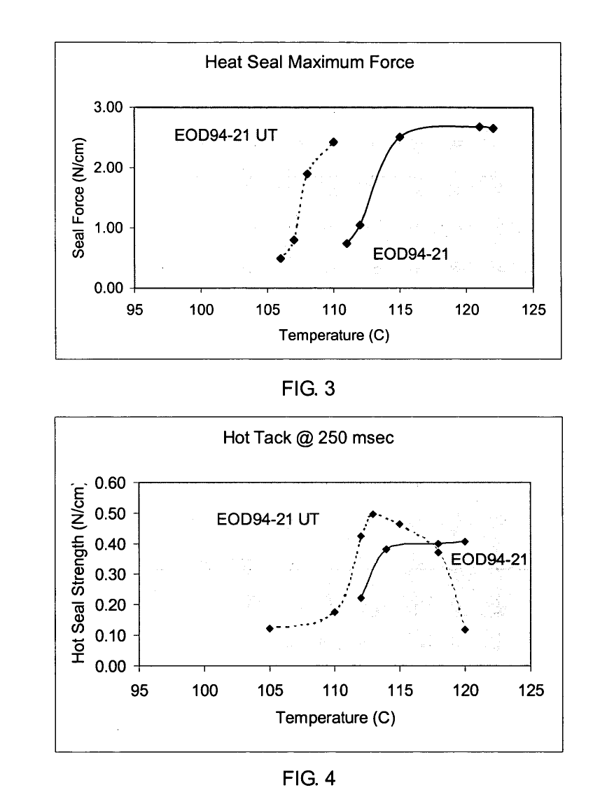

The copolymer has a melting point of about 121° C. and nominal melt index of 5 g/10 minutes. The film, both treated and untreated, is tested for heat seal properties. A graph showing the test results for Heat Seal maximum force is displayed as FIG. 3. A graph showing the test results for Hot Tack Seal Strength is displayed as FIG. 4.

### Example 2

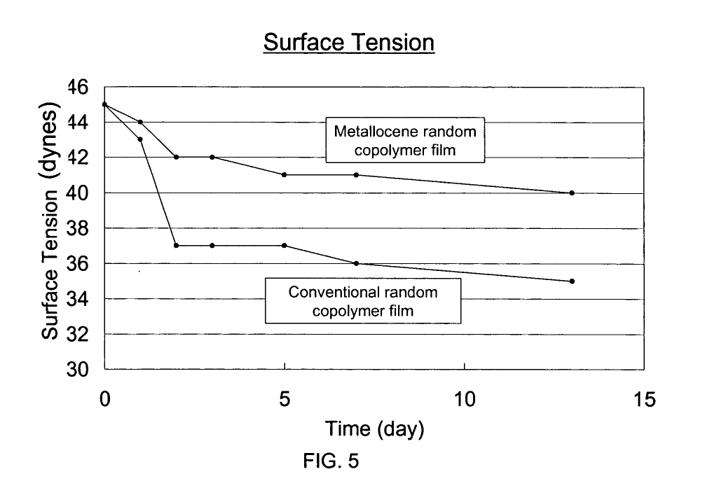

A random copolymer of propylene and ethylene prepared using a metallocene catalyst and having an ethylene content of 2.5 percent is used to prepare a film. The film is subjected to a corona treatment and tested for surface tension over time. The film produced retains the increased surface tension with time to a much greater extent than the film of Comparative Example B. A graph showing the test results for surface tension is displayed as FIG. 5.

### Comparative Example B

A conventional copolymer of propylene and ethylene prepared using a Ziegler Natta catalyst and having an ethylene content of 7% is used to prepare a film. The film is subjected to a corona treatment and tested for surface tension over time. The film produced retains the increased surface tension with time to a lesser extent than the film of Comparative Example B. A graph showing the test results for surface tension is displayed as FIG. 5.

### Comments Regarding Example 1 and Comparative Example A

FIG. 1 is a Heat Seal Maximum Force curve for film prepared in Example 1. The curve for the untreated film is indicated using dotted lines and labeled EODO1-05 and has a maximum heat seal force of about 2.7 N/cc at a temperature of about 104° C. The curve for the film treated with a corona heat treatment is indicated using a solid line and has a maximum heat seal force of about 2.5 N/cc at a temperature of about 100° C.

In FIG. 2, it can be seen that the hot tack seal strength at 250 msec for the untreated example film, indicated using dotted lines and labeled EODO1-05 has a maximum hot seal strength of about 0.52 N/cm at a temperature of about 103° C. The film treated with a corona heat treatment has a curve indicated using a solid line and has a maximum hot seal strength of about 0.43 N/cm at a temperature of about 106° C.

FIG. 3 is a Heat Seal Maximum Force curve for film prepared in Comparative Example A. The curve for the untreated film is indicated using dotted lines and labeled EOD94-21 and has a maximum heat seal force of about 2.5 N/cm at a temperature of about 110° C. The curve for the film treated with a corona heat treatment is indicated using a solid line and has a maximum heat seal force of about 2.5 N/cm at a temperature of about 115° C.

In FIG. 4, it can be seen that the hot tack seal strength at 250 msec for the untreated Comparative Example film, indicated using dotted lines and labeled EOD94-21 has a maximum hot tack seal strength of about 0.51 N/cm at a temperature of about 113° C. The film treated with a corona heat treatment has a curve indicated using a solid line and has a maximum hot seal strength of about 0.42 N/cm at a temperature of about 114° C.

It can be observed that the films of the present invention can achieve a maximum seal force at substantially lower temperatures than films prepared using conventional copolymers even though both polymers have similar melting points. It can also be observed that the copolymers useful with the present invention suffer less loss of properties during corona treatments as shown by the closer proximity of the curves in FIGS. 1&2 when compared to FIGS. 3&4.

### Comments Regarding Example 2 and Comparative Example B

As shown in FIG. 5, after corona treatment, a metallocene catalyzed isotactic polypropylene copolymer film retains increased surface tension better than a similar Ziegler-Natta polymer film.

What is claimed is:

1. A multiple-layer polymer film comprising a first layer comprising at least one metallocene catalyzed isotactic polypropylene or polypropylene copolymer film having novel surface attributes and attached thereto a second layer comprising a polymer film.

2. The multiple-layer polymer film of claim 1 wherein the at least one metallocene catalyzed isotactic polypropylene or polypropylene copolymer film is a polypropylene copolymer film.

3. The multiple-layer polymer film of claim 2 wherein the polypropylene copolymer film is prepared with propylene and ethylene and the ethylene content is about 9.5 percent or less.

4. The multiple-layer polymer film of claim 2 wherein the polypropylene copolymer film is prepared with propylene and ethylene and the ethylene content is from about 1 to about 7 percent.

5. The multiple-layer polymer film of claim 2 wherein the polypropylene copolymer film is prepared with propylene and ethylene and the ethylene content is from about 2 to about 6 percent.

6. The multiple-layer polymer film of claim 2 wherein the polypropylene copolymer film is prepared with propylene and ethylene and the ethylene content is from about 3 to about 5 percent.

7. The multiple-layer polymer film of claim 1 wherein the second layer comprising a polymer film is prepared with a metallocene catalyzed isotactic polypropylene or polypropylene copolymer film.

8. The multiple-layer polymer film of claim 1 wherein the second layer comprising a polymer film is prepared with a polymer film different from a metallocene catalyzed isotactic polypropylene or polypropylene copolymer film.

9. A polymer laminate comprising a substrate and a layer of polymer film, wherein the polymer film is a metallocene catalyzed isotactic polypropylene or polypropylene copolymer film having novel surface attributes.

10. The polymer laminate of claim 9 wherein the polymer film is a metallocene catalyzed isotactic polypropylene copolymer film.

11. The polymer laminate of claim 10 wherein the polypropylene copolymer film is prepared with propylene and ethylene and the ethylene content is about 9.5 percent or less.

12. The polymer laminate of claim 10 wherein the polypropylene copolymer film is prepared with propylene and ethylene and the ethylene content is from about 1 to about 7 percent.

13. The polymer laminate of claim 10 wherein the polypropylene copolymer film is prepared with propylene and ethylene and the ethylene content is from about 2 to about 6 percent.

14. The polymer laminate of claim 10 wherein the polypropylene copolymer film is prepared with propylene and ethylene and the ethylene content is from about 3 to about 5 percent.

15. A process for preparing a multiple-layer polymer film or a polymer film laminate comprising applying a layer of polymer film to a substrate wherein the polymer is a metallocene catalyzed isotactic polypropylene or polypropylene copolymer having novel surface attributes.

16. The process of claim 15 wherein the substrate is a polymer film.

17. The process of claim 15 wherein the substrate is other than a polymer film.

18. The process of claim 17 wherein the substrate is paper board or metal foil.

19. The process of claim 15 wherein the polymer film is applied to the substrate using an adhesive, welding or heat sealing.

20. The process of claim 15 wherein the polymer film is applied to the substrate using heat sealing.

21. The multiple-layer polymer film of claim 1 wherein the multiple-layer polymer film is a label.

22. The polymer laminate of claim 9 where in the polymer laminate is a food container.

23. The polymer laminate of claim 22 wherein the food container is a potato chip bag.
